(19) United States
(12) Patent Application Publication
(10) Pub. No.: US 2015/0007621 A1
(43) Pub. Date: Jan. 8, 2015

(54) DEADBOLT LOCK ASSEMBLY

(71) Applicant: TONG LUNG METAL INDUSTRY CO., LTD., Chiayi County (TW)

(72) Inventor: Tsung-Chung HUANG, Chiayi County (TW)

(21) Appl. No.: 14/321,001

(22) Filed: Jul. 1, 2014

(30) Foreign Application Priority Data
Jul. 3, 2013 (TW) 102212464

(51) Int. Cl. E05C 1/04

(52) U.S. Cl. CPC E05C 1/04
USPC 70/129

(57) ABSTRACT

A key-operated lock unit includes a frusto-conical inner case receiving a lock body and having opposite first and second case end rings. The first case end ring extends around a lock end plate of the lock body and engages an annular shoulder of the lock end plate. An engagement element projects axially from the first case end ring to engage the lock endplate and to position the first inner case relative to the lock body. An interlocking element on the second case end ring interlocks with an outer case covering the inner case to position the outer case relative to the inner case.

### CROSS-REFERENCE TO RELATED APPLICATION

This application claims priority of Taiwanese Application No. 102212464, filed on Jul. 3, 2013.

### BACKGROUND OF THE INVENTION

1. Field of the Invention

The present invention relates to a door lock, more particularly to a deadbolt lock device mountable on a door.

2. Description of the Related Art

Generally, an exterior door permitting exit and entry is usually provided with a deadbolt lock assembly which is used as an auxiliary lock in addition to a cylinder lock so as to enhance protection against burglary or illegal entry through the exterior door.

A typical deadbolt lock assembly includes a deadbolt installed on a door panel, and two long screw rods that interconnect inner and outer lock units. The outer lock unit includes a key-operated lock unit that is operated by using a key from the outside of the door, whereas the inner lock unit includes a rotary knob-set unit that can be operated manually from the inside of the door. Examples of such deadbolt lock assemblies are disclosed in U.S. Pat. Nos. 5,765,412, 7,596,975 and 7,900,489.

### SUMMARY OF THE INVENTION

Therefore, an object of the present invention is to provide a deadbolt lock assembly that has a reinforced structure and that may be manufactured at low cost using a simple process.

According to one aspect of the present invention, a deadbolt lock assembly for a door comprises a deadbolt mechanism, a knob-set unit and a key-operated lock unit. The knob-set unit is mountable to one side of the door, is connected to the deadbolt mechanism, and is user-operable to drive the deadbolt mechanism. The key-operated lock unit is mountable to another side of the door opposite to the knob-set unit, and includes a frusto-conical first inner case, a lock body and a first outer case.

The first inner case defines an axis, and has first and second case end rings that are opposite to each other and that extend around the axis. The second case end ring is wider than the first case end ring. The first case end ring has a first endmost ring section that extends axially, and a first engagement element that is disposed on the first endmost ring section. The second case end ring has a first interlocking element.

The lock body is disposed inside the first inner case, is connected to the deadbolt mechanism, and is operable using a key to drive the deadbolt mechanism. The lock body has a lock end plate exposed from the first case end ring. The lock end plate has a first annular rim extending out of the first endmost ring section, a second annular rim indented in radial inward directions from the first annular rim and sleeved by the first endmost ring section, an annular shoulder formed at a junction of the first and second annular rims and engaging an annular edge of the first endmost ring section, and a second engagement element disposed at the first annular rim.

The first outer case covers the first inner case, and has a cap plate abutting against an outer surface of the lock end plate, and a frusto-conical skirt extending divergingly from a periphery of the cap plate to the second case end ring. The skirt has a skirt end ring that is distal from the cap plate and that is formed with a second interlocking element.

The first engagement element projects in an axial outward direction from the annular edge of the first endmost ring section to the first annular rim, and engages the second engagement element to position the lock body relative to the first inner case. The second interlocking element interlocks with the first interlocking element to position the first outer case relative to the first inner case.

According to another aspect of the present invention, a deadbolt door lock assembly for a door comprises first and second lock units mountable on two opposite sides of the door, and a deadbolt mechanism connected to both of the first and second lock units.

The first lock unit includes a key-operated lock unit that has a frusto-conical first inner case, a first outer case, and a lock body disposed inside the first inner case.

The first inner case has first and second case end rings that are opposite to each other. The second case end ring is wider than the first case end ring. The first case end ring has a first endmost ring section that extends axially. The second case end ring has at least one first interlocking element.

The lock body is disposed inside the first inner case, and has a lock end plate exposed from the first case end ring. The lock end plate has a stepped circumferential periphery formed with an annular shoulder.

The first outer case encloses the first inner case and has a cap plate abutting against the lock end plate, and a frusto-conical skirt extending divergingly from a periphery of the cap plate to the second case end ring. The skirt has a skirt end ring distal from the cap plate and formed with at least one second interlocking element.

The stepped circumferential periphery is partially sleeved by the first endmost ring section. The first endmost ring section has an annular edge abutting against the annular shoulder. The at least one second interlocking element interlocks with the at least one first interlocking element to prevent the annular edge from moving away from the annular shoulder and to position the first outer case relative to the first inner case.

According to still another aspect of the present invention, a deadbolt door lock assembly for a door comprises first and second lock units mountable on two opposite sides of the door, and a deadbolt mechanism connected to both of the first and second lock units.

The first lock unit has a frusto-conical first inner case mountable to one side of the door, a first outer case covering the first inner case, and a lock body disposed inside the first inner case and connected to the deadbolt mechanism. The first inner case has first and second case end rings that are opposite to each other, and an intermediate ring section connected between the first and second case end rings. The second case end ring is wider than the first case end ring. The second case end ring has an annular flange that projects in radial outward directions from an outermost end of the second case end ring.

The first inner case further has a plurality of angularly spaced apart recessed parts, each of which is depressed in radial inward directions from an outer surface of the first inner case and extends to the outermost end of the second case end ring. The annular flange is flush with the outermost end, and has a plurality of widened flat parts extending respectively into the recessed parts and a plurality of protrusions respectively and axially projecting from surfaces of the widened flat parts opposite to the recessed parts. The annular flange is adapted to abut against an outer surface of the door, and the protrusions are adapted to be positioned against an inner wall surface of a mounting hole in the door.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective exploded view of a deadbolt lock assembly according to the preferred embodiment of the present invention;

FIG. 2 is a perspective exploded view of a key-operated lock unit of the deadbolt lock assembly according to the preferred embodiment;

FIG. 3 is another perspective exploded view of the key-operated lock unit viewed from a different angle;

FIG. 4 is a perspective exploded view of a knob-set unit of the deadbolt lock assembly according to the preferred embodiment;

FIG. 5 is another perspective exploded view of the knob-set unit viewed from a different angle;

FIG. 6 is a cross-sectional view of the deadbolt lock assembly mounted to a door; and

FIG. 7 is a schematic view illustrating the key-operated lock unit mounted to the door.

### DETAILED DESCRIPTION OF THE PREFERRED EMBODIMENT

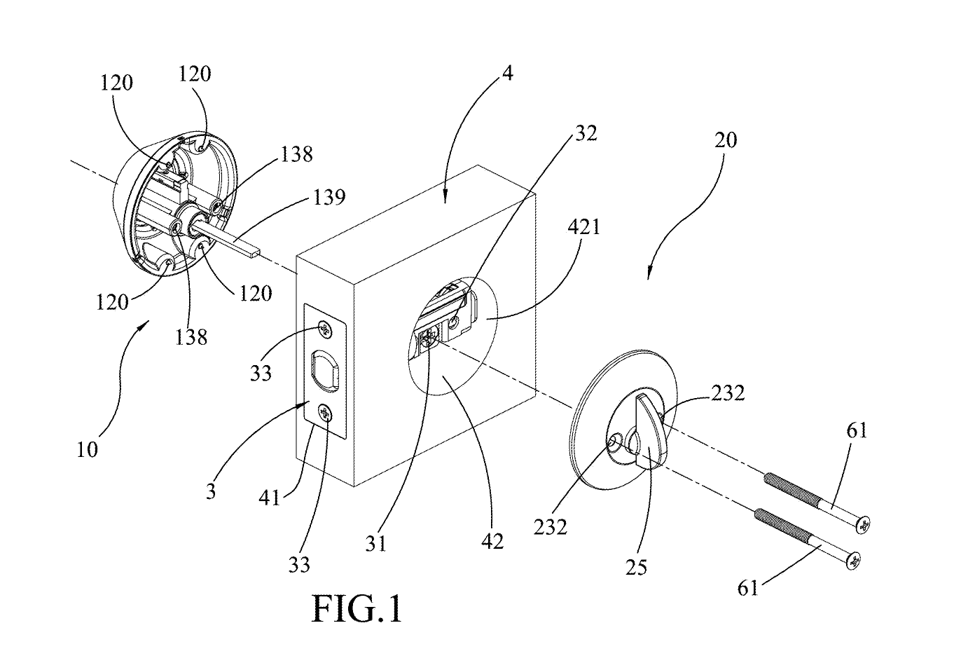

Referring to FIG. 1, a deadbolt lock assembly for a door 4 according to a preferred embodiment of the present invention is shown to include a first lock unit 10 and a second lock unit 20 mountable on two opposite sides of the door 4, and a deadbolt mechanism 3 connected to both of the first and second lock units 10, 20.

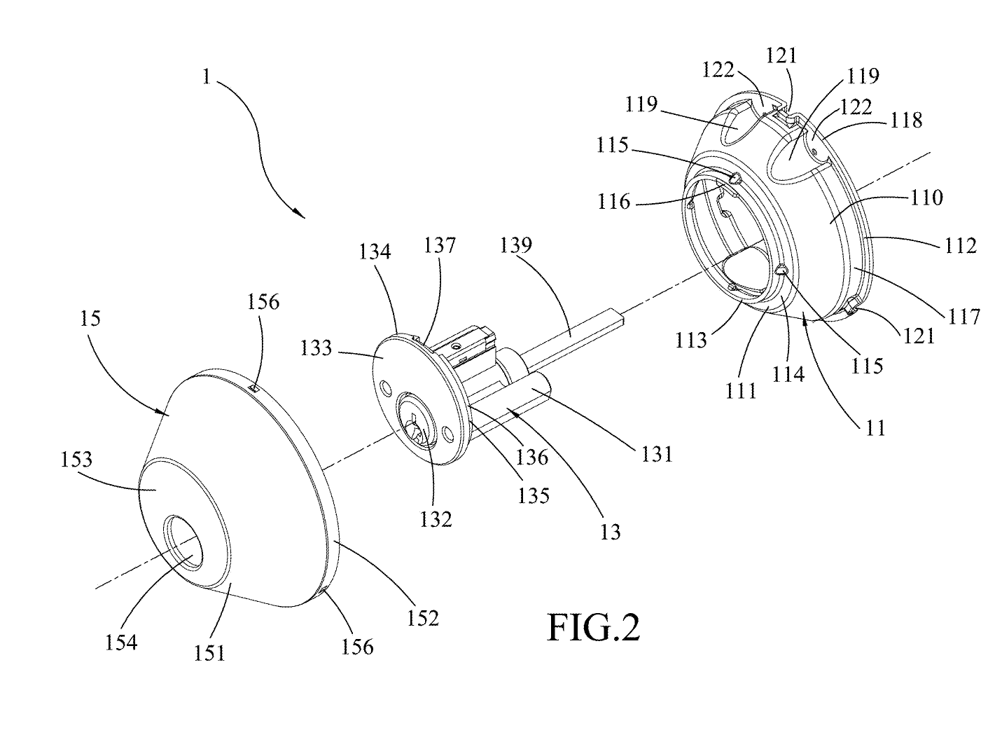

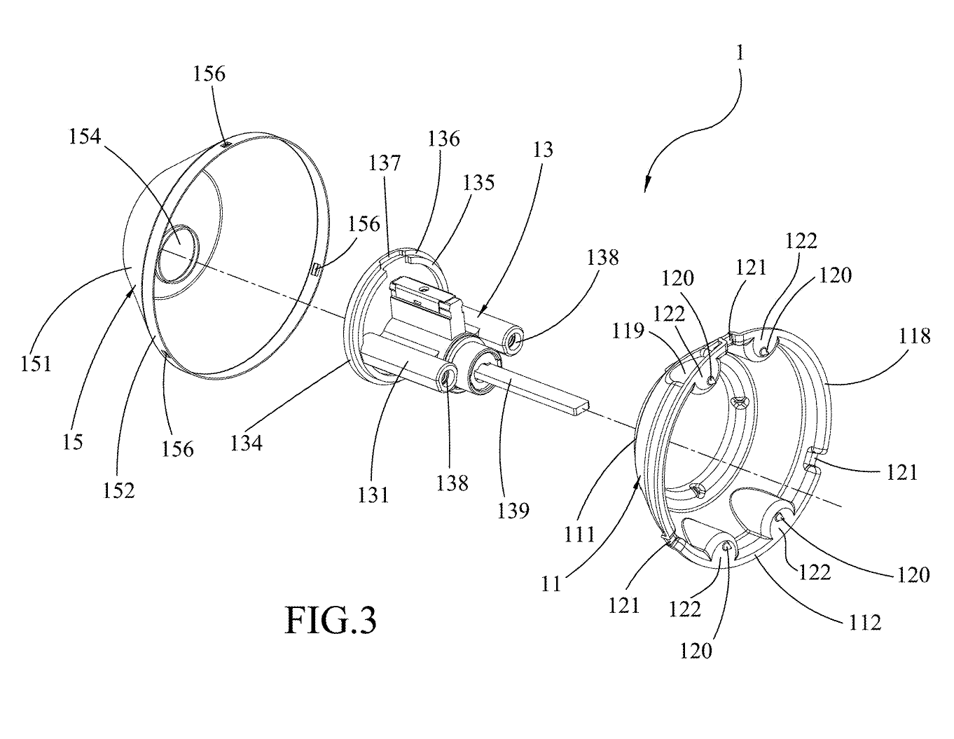

Further referring to FIGS. 2, 3 and 6, the first lock unit 10 includes key-operated lock unit 1 mounted to one side of the door 4. The key-operated lock unit 1 includes a frusto-conical first inner case 11, a lock body 13 and a first outer case 15.

The first inner case 11 defines an axis, and has a first case end ring 111 and a second case end ring 112 that are opposite to each other and that extend around the axis. The second case end ring 112 is wider than the first case end ring 111 in diameter. The first case end ring 111 has a first endmost ring section 113 extending axially away from the second case end ring 112, an inner ring section 114 extending in radial outward directions from an inner end of the first endmost ring section 113, a plurality of reinforcing ribs 115 disposed at a junction of the first endmost ring section 113 and the inner ring section 114, and a first engagement element 116 disposed on an outer end of the first endmost ring section 113 opposite to the inner ring section 114. In particular, the first engagement element 116 projects in an axial outward direction from an annular edge of the first endmost ring section 113.

The second case end ring 112 has a second endmost ring section 117 extending axially with respect to the axis of the first inner case 11, an annular flange 118 projecting in radial outward directions from an outermost end of the second endmost ring section 117, and a plurality of first interlocking elements 121 disposed at the outermost end of the second endmost ring section 117 and angularly spaced apart from each other. In this embodiment, each of the first interlocking elements 121 is formed as a U-shaped notch that is indented axially from the outermost end of the second endmost ring section 117 and from the annular flange 118.

The first inner case 11 further has an intermediate ring section 110 between the first case end ring 111 and the second case end ring 112, and a plurality of angularly spaced apart recessed parts 119. Each of the recessed parts 119 is depressed in radial inward directions from outer surfaces of the intermediate ring section 110 and the second endmost ring section 117. The outermost end of the second endmost ring section 117 is indented radially and inwardly corresponding to each of the recessed parts 119. The annular flange 118 is flush with the outermost end of the second endmost ring section 117, and has a plurality of widened flat parts 122 extending respectively into the recessed parts 119 and a plurality of protrusions 120 respectively and axially projecting from surfaces of the widened flat parts 122 opposite to the recessed parts 119.

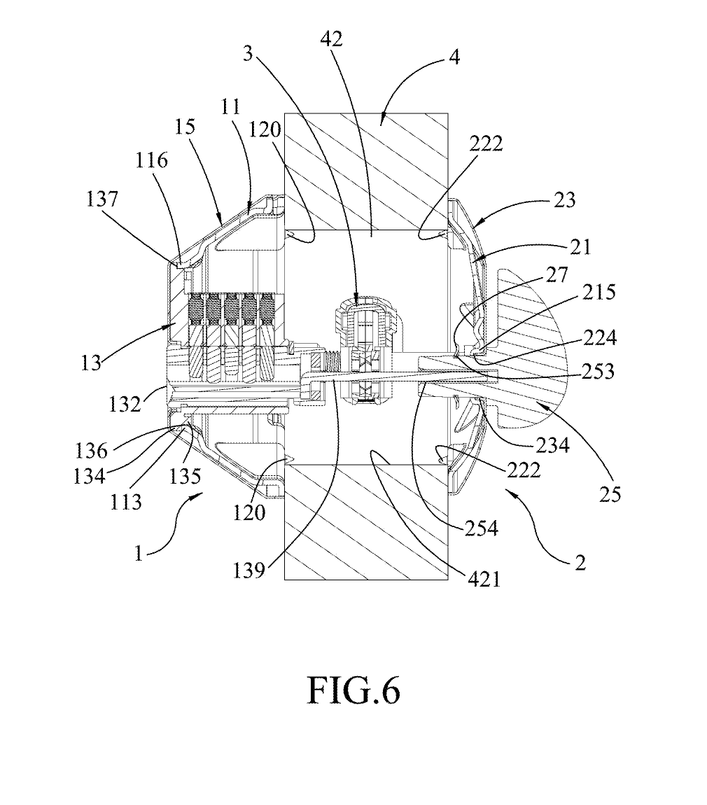

The lock body 13 is disposed partly inside the first inner case 11, is connected to the deadbolt mechanism 3, and is operable using a key (not shown) to drive the deadbolt mechanism 3. The lock body 13 has a lock body case 131, and a key plug 132 disposed in the lock body case 131 and connected to a tailpiece 139. The lock body case 131 has a lock end plate 133 exposed from the first case end ring 111 of the first inner case 11, and two threaded holes 138 spaced apart from each other and disposed on two opposite sides of the key plug 132. The key plug 132 is operable using the key to rotate with respect to the lock body case 131 so as to drive rotation of the tailpiece 139 that is connected to the deadbolt mechanism 3 (see FIG. 6).

The lock end plate 133 has a first annular rim 134 extending out of the first endmost ring section 113, a second annular rim 135 indented in radial inward directions from the first annular rim 134 and sleeved by the first endmost ring section 113, an annular shoulder 136 formed at a junction of the first annular rim 134 and the second annular rim 135 and engaging the annular edge of the first endmost ring section 113, and a second engagement element 137 disposed at the first annular rim 134. In this embodiment, the first engagement element 116 is formed as an axially projecting tongue, and the second engagement element 137 is formed as a groove indented radially from a circumferential outer surface of the first annular rim 134 to receive fittingly the tongue.

The first outer case 15 covers the first inner case 11. The first outer case 15 has a cap plate 153 abutting against an outer surface of the lock end plate 133 and formed with a through hole 154, and a frusto-conical skirt 151 extending divergingly from a periphery of the cap plate 153 to the second case end ring 112. The skirt 151 has a skirt end ring 152 that is distal from the cap plate 153 and that is formed with a plurality of second interlocking elements 156. In this embodiment, each of the second interlocking elements 156 is formed as a stud that projects in radial inward directions from an inner surface of the skirt end ring 152 into a corresponding one of the notch-form first interlocking elements 121.

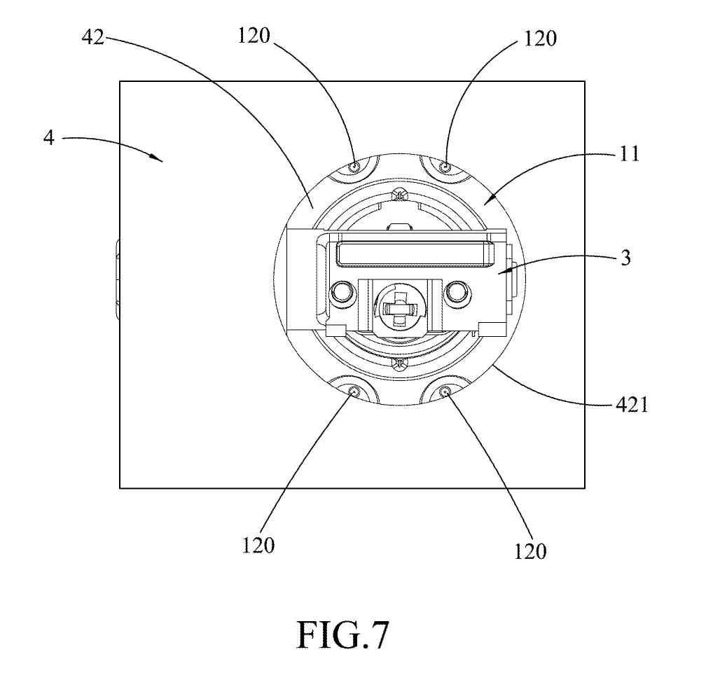

Referring to FIGS. 1 to 3 and 6 to 7, for assembling the key-operated lock unit 1, the lock body 13 is placed into the first inner case 11 such that the annular edge of the first endmost ring section 113 engages the annular shoulder 136. Further, the first engagement element 116 projects in the axial outward direction to the first annular rim 134 and engages the second engagement element 137 to position the lock body 13 relative to the first inner case 11. Then, the first outer case 15 is placed to cover the assembly of the first inner case 11 and the lock body 13 with the through hole 154 aligned with the key plug 132. The second interlocking elements 156 interlock respectively with the first interlocking elements 121 to prevent the annular edge 118 from moving away from the annular shoulder 136 and to position the first outer case 15 relative to the first inner case 11.

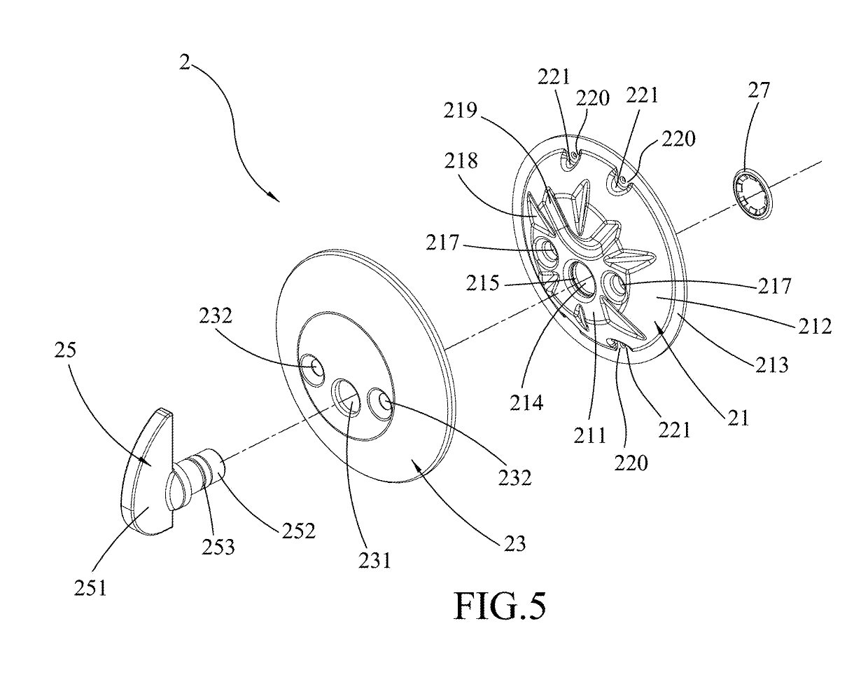

Referring to FIGS. 1, 4, 5 and 6, the second lock unit 20 includes a knob-set unit 2 that is mounted to another side of the door 4 opposite to the key-operated lock unit 1 of the first lock unit 10, and that is connected to the deadbolt mechanism 3. The knob-set unit 2 includes a second inner case 21 mounted to the door 4, a second outer case 23 covering the second inner case 21, a knob 25 extending through the second outer case 23 and the second inner case 21, and a retaining ring 27 retaining the knob 25.

The second inner case 21 has an inner ring portion 211, an outer ring portion 213 extending around and wider than the inner ring portion 211 in diameter, and an intermediate ring portion 212 connected to and bent between the inner and outer ring portions 211, 213. The inner ring portion 211 has two hollow columns 216 that extend in an axial direction toward the outer ring portion 213 and that are diametrically spaced apart from each other, a first central hole 214 that is disposed between the columns 216, a first annular flange 215 that axially extends from a periphery of the first central hole 214 in a direction toward the outer ring portion 213, and an annular lip 224 that extend in radial inward directions from the first annular flange 215. Each of the columns 216 defines a first fastening hole 217 therein.

The second inner case 21 further has a plurality of substantially straight ribs 218 and a curved rib 219 disposed at a junction of the inner and intermediate ring portions 211, 212. In this embodiment, the second inner case 21 has six of the straight ribs 218 that are angularly spaced apart from each other. Each straight rib 218 has two ends respectively extending to the inner ring portion 211 and the intermediate ring portion 212, and protrudes in the axial direction from inner surfaces of the inner and intermediate ring portions 211 and 212. The curved rib 219 is substantially U-shaped, and is curved around one of the straight ribs 218.

The second inner case 21 is formed with a plurality of angularly spaced apart recessed parts 221 depressed in radial inward directions from an outer surface of the intermediate ring portion 212 and extending to a junction of the intermediate ring portion 212 and the outer ring portion 213. The outer ring portion 213 extends in radial outward directions from the junction, and has a plurality of widened flat parts 220 respectively extending into the recessed parts 221, and a plurality of protrusions 222 projecting axially and respectively from the widened flat parts 220 in a direction opposite to the recessed parts 221.

The second outer case 23 has a disk-like shape and has a second central hole 231 aligned with the first central hole 214, and two second fastening holes 232 respectively disposed on two sides of the second central hole 231. The second outer case 23 has a second annular flange 234 axially extending from a peripheral edge of the second central hole 231 into the first central hole 214 and the first annular flange 215 and abutting against the annular lip 224.

The knob 25 is connected to the deadbolt mechanism 3, and is user-operable to drive the deadbolt mechanism 3. The knob 25 includes a knob part 251, and a shaft part 252 connected to the knob part 251. The shaft part 252 has an annular notch 253 depressed radially from an outer surface of the shaft part 252, and a socket 254 extending axially in the shaft part 252. For assembling the knob-set unit 2, the shaft part 252 extends through the second central hole 231 of the second outer case 23 and the first central hole 214 of the second inner case 21, and is sleeved by an inner surface of the second annular flange 234 of the second outer case 23 and the annular lip 224 of the inner ring portion 211 of the second inner case 21, such that the knob 25 may be rotated stably during user operation. Then, the retaining ring 27 engages the annular notch 253 so as to retain the knob 25.

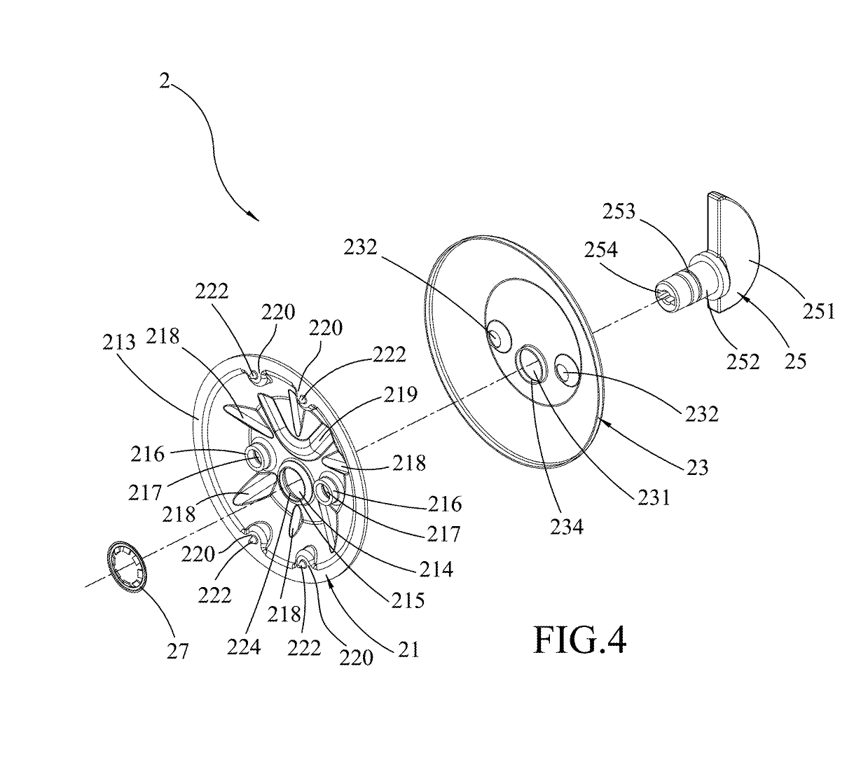

Referring to FIGS. 1, 6 and 7, the deadbolt mechanism 3 has a tailpiece through hole 31 and two third fastening holes 32 (only one is shown). For assembling the deadbolt lock assembly of this embodiment, the deadbolt mechanism 3 is first placed into the door 4 from a side surface 41 of the door 4, and is fastened in the door 4 by two screws 33 extending through the side surface 41 of the door 4. Then, the key-operated lock unit 1 (the first lock unit 10) is mounted to one side of the door 4, so that the annular flange 118 (see FIG. 2) of the first inner case 11 abuts against an outer surface of the door 4 and that the protrusions 120 of the annular flange 118 abut against an inner wall surface 421 of a mounting hole 42 in the door 4. At this time, the tailpiece 139 extends through the tailpiece through hole 31 in the deadbolt mechanism 3. Subsequently, the knob-set unit 2 (the second lock unit 20) is mounted to another side of the door 4 opposite to the key-operated lock unit 1, so that the protrusions 222 of the outer ring portion 213 (see FIG. 4) of the second inner case 21 abut against the inner wall surface 421 of the mounting hole 42 and that the tailpiece 139 is inserted into the socket 254 in the shaft part 252 (see FIG. 4) of the knob 25. As a result, each of the threaded holes 138 in the lock body 13 is aligned with a corresponding third fastening hole 32 in the deadbolt mechanism 3, a corresponding second fastening hole 232 (see FIG. 4) in the second outer case 23, and a corresponding first fastening hole 217 (see FIG. 4) in the second inner case 21. Then, two screws 61 are inserted through the respective second fastening holes 232, the respective first fastening holes 217 and the respective third fastening holes 32, and are threadedly engaged with the respective threaded holes 138 in the lock body 13 such that the deadbolt lock assembly is mounted to the door 4 completely.

In sum, the deadbolt lock assembly according to the present invention can be manufactured by a relatively simple process at low cost. Particularly, all of the first and second inner cases 11, 21 and the first and outer cases 15, 23 may be made from a plate material using a stamping process. Further, it is relatively easy to mount the deadbolt lock assembly to the door 4.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A deadbolt lock assembly for a door, comprising:
a deadbolt mechanism;
a knob-set unit mountable to one side of the door, and connected to said deadbolt mechanism, said knob-set unit being user-operable to drive said deadbolt mechanism; and
a key-operated lock unit mountable to another side of the door opposite to said knob-set unit, and including a frusto-conical first inner case, a lock body and a first outer case;
said first inner case defining an axis and having first and second case end rings that are opposite to each other and that extend around the axis, said second case end ring being wider than said first case end ring, said first case end ring having a first endmost ring section that extends axially and a first engagement element that is disposed on said first endmost ring section, said second case end ring having at least one first interlocking element;
said lock body being disposed inside said first inner case and connected to said deadbolt mechanism, said lock body being operable using a key to drive said deadbolt mechanism, said lock body having a lock end plate that is exposed from said first case end ring, said lock end plate having a first annular rim that extends out of said first endmost ring section, a second annular rim that is indented in radial inward directions from said first annular rim and that is sleeved by said first endmost ring section, an annular shoulder that is formed at a junction of said first and second annular rims and that engages an annular edge of said first endmost ring section, and a second engagement element that is disposed at said first annular rim;
said first outer case covering said first inner case and having a cap plate that abuts against an outer surface of said lock end plate, and a frusto-conical skirt that extends divergingly from a periphery of said cap plate to said second case end ring, said skirt having a skirt end ring that is distal from said cap plate and that is formed with at least one second interlocking element;
said first engagement element projecting in an axial outward direction from said annular edge of said first endmost ring section to said first annular rim, and engaging said second engagement element to position said lock body relative to said first inner case, said at least one second interlocking element interlocking with said at least one first interlocking element to position said first outer case relative to said first inner case.

2. The deadbolt lock assembly as claimed in claim 1, wherein said first engagement element is formed as an axially projecting tongue, and said second engagement element is formed as a groove that is indented radially from a circumferential outer surface of said first annular rim to receive fittingly said tongue.

3. The deadbolt lock assembly as claimed in claim 1, wherein said first case end ring further has an inner ring section that extends in radial outward directions from an inner end of said first endmost ring section opposite to said first engagement element, and at least one reinforcing rib that is disposed at a junction of said first endmost ring section and said inner ring section.

4. The deadbolt lock assembly as claimed in claim 3, wherein said second case end ring further has a second endmost ring section that extends axially with respect to the axis of said first inner case, and an annular flange that projects in radial outward directions from an outermost end of said second endmost ring section, said at least one first interlocking element being disposed at said outermost end of said second endmost ring section.

5. The deadbolt lock assembly as claimed in claim 4, wherein said at least one first interlocking element includes a plural ity of said first interlocking elements, which are angularly spaced apart from each other and each of which is formed as a notch that is indented axially from said outermost end of said second endmost ring section and from said annular flange, and wherein said at least one second interlocking element includes a plurality of said second interlocking elements, which are angularly spaced apart from each other and each of which is formed as a stud that projects in radial inward directions from an inner surface of said skirt end ring into said notch.

6. The deadbolt lock assembly as claimed in claim 4, wherein said first inner case further has an intermediate ring section between said first and second case end rings, and a plurality of angularly spaced apart recessed parts, each of which is depressed in radial inward directions from outer surfaces of said intermediate ring section and said second endmost ring section, said outermost end of said second endmost ring section being indented radially and inwardly corresponding to each of said recessed parts, said annular flange having a plurality of widened flat parts that extend respectively into said recessed parts and a plurality of protrusions that project respectively and axially from surfaces of said widened flat parts opposite to said recessed parts, said annular flange being adapted to abut against an outer surface of the door and said protrusions being adapted to abut against an inner wall surface of a mounting hole in the door.

7. The deadbolt lock assembly as claimed in claim 1, wherein said knob-set unit includes a second inner case adapted to be mounted to the door, a second outer case covering said second inner case, and a knob extending through said second outer case and said second inner case, and connected to said deadbolt mechanism, said knob being user-operable to drive said deadbolt mechanism.

8. The deadbolt lock assembly as claimed in claim 7, wherein said second inner case has an inner ring portion, an outer ring portion extending around said inner ring portion, an intermediate ring portion connected to and bent between said inner and outer ring portions, and at least one substantially straight rib and a curved rib disposed at a junction of said inner and intermediate ring portions.

9. The deadbolt lock assembly as claimed in claim 8, wherein said second inner case is formed with a plural ity of angularly spaced apart recessed parts depressed in radial inward directions from an outer surface of said intermediate ring portion and extending to a junction of said intermediate ring portion and said outer ring portion, said outer ring portion extending in radial outward directions from said junction, and having a plurality of widened flat parts that respectively extend into said recessed parts, and a plurality of protrusions that project axially and respectively from said widened flat parts in a direction opposite to said recessed parts.

10. The deadbolt lock assembly as claimed in claim 8, wherein said inner ring portion of said second inner case has a first central hole, a first annular flange axially extending from a periphery of said first central hole in a direction toward said outer ring portion, and an annular lip extending in radial inward directions from said first annular flange; and
wherein said second outer case is formed with a second central hole aligned with said first central hole, and has a second annular flange axially extending from a peripheral edge of said second central hole into said first central hole and said first annular flange and abutting against said annular lip.

11. A deadbolt lock assembly for a door, comprising:
first and second lock units mountable on two opposite sides of the door, and a deadbolt mechanism connected to both of said first and second lock units;
said first lock unit including a key-operated lock unit that has a frusto-conical first inner case, a first outer case, and a lock body disposed inside said first inner case;
said first inner case having first and second case end rings that are opposite to each other, said second case end ring being wider than said first case end ring, said first case end ring having a first endmost ring section that extends axially, said second case end ring having at least one first interlocking element;
said lock body being disposed inside said first inner case, and having a lock end plate that is exposed from said first case end ring, said lock end plate having a stepped circumferential periphery that is formed with an annular shoulder;
said first outer case enclosing said first inner case and having a cap plate that abuts against said lock end plate, and a frusto-conical skirt that extends divergingly from a periphery of said cap plate to said second case end ring, said skirt having a skirt end ring that is distal from said cap plate and that is formed with at least one second interlocking element;
said stepped circumferential periphery being partially sleeved by said first endmost ring section, said first endmost ring section having an annular edge that abuts against said annular shoulder, said at least one second interlocking element interlocking with said at least one first interlocking element to prevent said annular edge from moving away from said annular shoulder and to position said first outer case relative to said first inner case.

12. The deadbolt lock assembly as claimed in claim 11, wherein said stepped circumferential periphery of said lock end plate has a first annular rim exposed from said first endmost ring section, a second annular rim indented radially and inwardly from said first annular rim and sleeved by said first endmost ring section, said annular shoulder being at a junction of said first and second annular rims.

13. The deadbolt lock assembly as claimed in claim 12, wherein said first inner case further has a first engagement element projecting axially and outwardly from said annular edge of said first endmost ring section, said lock end plate further having a second engagement element that is formed in said first annular rim to engage said first engagement element such that said first inner case is positioned relative to said lock body.

14. A deadbolt lock assembly for a door, comprising:
first and second lock units mountable on two opposite sides of the door, and a deadbolt mechanism connected to both of said first and second lock units;
said first lock unit having a frusto-conical first inner case that is mountable to one side of the door, a first outer case that covers said first inner case, and a lock body that is disposed inside said first inner case and that is connected to said deadbolt mechanism;
said first inner case having first and second case end rings that are opposite to each other, and an intermediate ring section that is connected between said first and second case end rings, said second case end ring being wider than said first case end ring;
said second case end ring having an annular flange that projects in radial outward directions from an outermost end of said second case end ring;
said first inner case further having a plurality of angularly spaced apart recessed parts, each of which is depressed inwardly and radially from an outer surface of said first inner case and extends to said outermost end of said second case end ring, said annular flange being flush with said outermost end and having a plurality of widened flat parts that extend respectively into said recessed parts and a plurality of protrusions that project respectively and axially from surfaces of said widened flat parts opposite to said recessed parts, said annular flange being adapted to abut against an outer surface of the door and said protrusions being adapted to be positioned against an inner wall surface of a mounting hole in the door.

15. The deadbolt lock assembly as claimed in claim 14, wherein said second case end ring further has a second endmost ring section that has said outermost end of said second case end ring and that is connected to said intermediate ring section, said recessed parts being inwardly and radially depressed from outer surfaces of said intermediate ring section and said second endmost ring section.
